(19) United States
(12) Patent Application Publication
(10) Pub. No.: US 2012/0290454 A1
(43) Pub. Date: Nov. 15, 2012

(54) Nonfinancial Asset Valuation And Depreciation

(76) Inventor: Joel Jameson, Los Altos, CA (US)

(21) Appl. No.: 13/515,824

(22) PCT Filed: Apr. 28, 2010
(86) PCT No.: PCT/US10/32777

§ 371 Date: Jun. 14, 2012

Related U.S. Application Data
(60) Provisional application No. 61/214,740, filed on Apr. 28, 2009.
(60) Provisional application No. 61/273,323, filed on Aug. 1, 2009.

(51) Int. Cl. G06Q 40/00

(52) U.S. Cl. 705/30

(57) ABSTRACT

A new method to depreciate nonfinancial assets is presented, correcting a problem with prior-art depreciation methods that implicitly assumes a zero discount rate. How to implement the method within a financial accounting context and within ad hoc decision making contexts is disclosed. The method has particular applicability for lease accounting, a matter currently under consideration by global accounting boards.

### CROSS REFERENCE TO RELATED APPLICATIONS

The present application claims priority to U.S. Provisional Patent Application 61/214,740 filed on Apr. 28, 2009 and claims priority to Provisional Patent Application 61/273,323 filed on Aug. 1, 2009. The present application hereby incorporates by reference U.S. Pat. No. 7,620,573 referred to herein as “Pat0034” and U.S. Pat. No. 7,624,049 referred to herein as “Pat0036” in their entirety.

### BACKGROUND TECHNICAL FIELD

The present invention regards financial accounting methods and computer systems to value nonfinancial assets and associated depreciation, particularly within the context of double-entry financial accounting computer systems based upon credits and debits.

### BACKGROUND DESCRIPTION OF PRIOR ART

Clear, accurate accounting methods are fundamental to a sound economy because they are the objective measures for market participants to make economic decisions. However, current day asset depreciation methods are deficient because of what is termed here as the “Fundamental Depreciation Problem.” Because almost all companies depreciate assets, this problem is ubiquitous and could explain both why cashflow analysis is generally prefered over analysis of financial statements for investment decisions, and the why there is short term focus throughout the business world.

This disclosure frequently uses a same Base-case example as a starting point for analysis and demonstration, in order to facilitate comparison and in order to avoid consideration of irrelvant detail variation. In the Base-case, a Company A purchases an airplane on Dec. 31, 2000, for $1200. The company has a 10% cost of capital, and uses 10% as its discount rate. The airplane has a useful life of five years,

Today, virtually all asset depreciation methods entail allocating, or spreading-out, an initial purchase price, or value, across multiple future periods, as shown in FIG. 1. Four different depreciation schedules are shown:
Straight-line depreciation in Column B, the most commonly used type of depreciation,
Double-declining balance in Column D, one of several types of accelerated depreciation,
Sinking fund in Column F, what might be called deaccelerated depreciation,
Proportional in Column H, reflecting anticipated usage.

The annual charge (expense) is shown in the respective columns, each column totaling the initial airplane value of $1200.00. So, for instance, Column C shows the annual charge under straight-line depreciation, totalling the $1200.00. In double entry accounting, the annual charge is expensed, appearing on the income statement and reducing the airplane asset-account value.

Next to Columns B, D, F and H in FIG. 1, the present values of each charge is shown. So, for example, the present value of the 2003 charge under straight-line depreciation is 180.32 (240/1.1³).

When the present values in each column are totalled, the totals are less than 1200.00, as can be seen in Cells C7, E7, G7, and 17, which is The Fundamental Depreciation Problem. As of Dec. 31, 2010, there are two contradictory valuations: the purchase price (1200.00) and the various total present values. Which is correct? Since the purchase price is a fair market value and since present value is the fundamental concept in finance, this is a real dilemma. If a zero discount rate were assumed, then the dilemma would be resolved, but a zero discount rate violates basic economic and financial theory, that asserts that a positive return is required by any investor. This leads to the conclusion that the charges shown in Columns B, D, F and H of FIG. 1 are too low:, for if they were higher, then the present values might equal the purchase price, 1200.00. But this raises the problem of determining and using such higher charges. Furthermore, the Fundamental Depreciation Problems leads to three other problems.

Most importantly, the Fundamental Depreciation Problem leads to short-termism, in which management and investments decisions are made based upon short-, rather than long-, term expectations and gains. To see this consider a Company B, identical to Company A, except that Company B purchases multiple airplanes that have a useful life of only one year. Further, assume a universal return of 10% on all assets and investments. Both companies purchase one or more airplanes on Dec. 31, 2000, each company's purchases totalling $1200. At the end of year 2001, Company A still has its airplane asset, with a value of about $930.00 (1200.00 minus B2, D2, F2, or H2 of FIG. 1), plus some revenue from ticket sales. Meanwhile, Company B has total assets of $1320 (1200.00*1.1), likely showing superior performance over Company A, because Company A has essentially about $930.00 tied-up in the airplane asset, seemingly yielding nothing. Stated differently, Company B has the financial reporting advantage because it can convert all of its 1200.00 airplane investment into recognized gains, while Company A cannot. Because of this, there is pressure on Company A to convert to Company B's short-term focus.

The second problem caused by the Fundamental Depreciation Problem is that nonfinancial assets are undervalued. Clearly, the charges (expenses) are too low, as demonstrated in FIG. 1, for who would purchase the airplane, only to receive the charges shown in Columns B, D, F, or H, only to earn a zero return, only to recupe their 1200.00 investment? With the charges somehow being higher, there will be more value present than indicated by decrementing the 1200.00 initial value over time. This will be demonstrated subsequently.

The third problem caused by the Fundamental Depreciation Problem is that it leads to a failure to distingiush between capital gains and operational performance. So, for instance, suppose that over the course of the five years between the end of 2000 and the end of 2005, Company A has an annual return of 8% on its 1200.00 airplane purchase. Assuming that revenue is roughtly proportional to the charges (depreciation expenses), revenue will always be greater than the charges, leading to positive net and comprehensive income each year, but incorrectly suggesting operational excellence. This is because the 8% return is below the 10% cost of capital. The shareholders of Company A would be well advised to close Company A and invest the 1200.00 elsewhere, possibly purchasing the airplane and making it available to other airlines, in order to earn the 10%. Stated differently and simply, because of the Fundamental Depreciation Problem, the opportunity cost of capital is not included in asset depreciation expening.

In the early 1980s, the consulting firm Stern Stewart & Co. developed the concept of economic value added, or EVA. The cost of capital is subtracted from measured income to yield EVA. While EVA addresses the above mentioned third problem caused by the Fundamental Depreciation Problem, it does so on a total company-, or division-, wide basis and not on an individual asset, micro-basis. While it uses accounting data, it does not provide data to accounting systems, specifially credits and debits. One generally recognized problem with EVA is that it penalizes new products. This occurs because new products can require significant new investment at the beginning, and such new investment increases the cost of the capital charge, making new products appear less profitable and worthwhile.

The U.S. financial accounting standards board (FASB, Financial Accounting Standards Board) and the international accounting standards board (IASB, International Accounting Standards Board) have sought to show all assets and liabilities on the balance sheet at Fair value, because traditional historic values are of little relevance or usefulness. With respect to nonfinancial assets, no progress has been made, with the boards essentially continuing with decades' old depreciation methods. While many nonfinancial assets can be appraised at any time, and such appraisals used for Fair-value mark-to-market accounting, such appraisals are too expensive and impractical to be performed on a periodic basis. Given the need for accurate, valid, and useful asset values, and given the analysis conducted elsewhere in this disclosure suggesting that existing depreciation methods result in under-valuation, there is a need for simple accurate, valid, and useful valuation of nonfinancial assets, and associated accounting methods and procedures.

The Fundamental Depreciation Problem also underpins much of the difficulty regarding lease accounting, a matter presently under consideration by the accounting boards. This matter has been debated for decades and has eluded satisfactory resolution. Both the FASB and the IASB are proposing to capitalize all leases, to dispense with the operating lease classification, to have lessees recognize leased assets on their balance sheets, to have lessees recognize lease-payment liabilities on their balance sheets, and to postpone consideration of lessor and leaseback accounting, in order to at least partly meet an upcoming deadline. Under the proposal, the lessee expenses both interest on the lease payment obligations and straight-line depreciation on leased assets. Lessors and lessees complain that the approach is illogical and that it inappropriately results in lessee expenses that are initially high and then progressively lower thereafter. Although the Equipment Lease and Finance Association (ELFA), a U.S. lessor trade organization, has proposed using a sinking-fund depreciation method for the asset component of a lessee's lease, the FASB has rejected such approach. The FASB argues that such an approach does not reflect economic reality. What the FASB and the ELFA fail to recognize is the Fundamental Depreciation Problem and the associated inappropriateness of an implicit zero discount rate in straight-line depreciation. Likewise, they do not recognize why they are in conflict with each other. The conflict arises due to the contradictory discounting perspectives implicitly employed by these organizations. ELFA argues for a single constant discount rate applicable to both the lease payment obligation and the sinking-fund depreciation, whereas the FASB argues for a positive discount rate applicable to the payment liability and a zero discount rate applicable to the asset, as dictated by a tradition that is shown above to be incorrect. The ELFA has also complained of the complexity associated with the FASB's approach to lessee accounting.

Part of the reason that the accounting boards have postponed fuller consideration of lease accounting is a general confusion regarding how to handle asset interests diversely owned by multiple parties, e.g. lessors and lessees, which result from both simple leases and leasebacks. Contributing to the confusion is the traditional practice of identifying a single controlling owner of a whole asset, and then basing the accounting upon such an identification. Today, however, the economy is evermore focused upon separating and dividing asset interests and rights as occurs in the cases of financial instruments and house timeshares. Thus, identifying a single controlling asset owner is apt to become increasingly difficult.

The above four depreciation methods, and similar methods, are frequently used apart from formal financial accounting systems. They are employed, for instance, in ad hoc analyses, transaction decisions, buy-versus-rent decisions, business plan preparation, and the like. But due to the Fundamental Depreciation Problem, such practices can result in inaccurate analyses, as described above. Thus it is clearly desirable to address the Fundamental Depreciation Problem in a manner that permits more accurate ad hoc analyses, transaction decisions, buy-versus-rent decisions, business plan preparation, and the like.

There are multiple ways of calculating sinking-fund depreciation, all yielding the same results, but perhaps the simpliest is what is sometimes call mortgage amortization. In mortgage amortization, the asset is assumed to be like a mortgage, in which regular periodic payments are received. Between payments, the mortgage/asset value appreciates according to the interest rate, but when once the payment is received, the value decreases. The value decraeses are the amounts about which the asset is depreciated. So in case of the airplane, a mortgage of 1200.00 at 10% interest, five yearly payments, would have an annual payment of $316.56, using standard loan payment calculation methods. Over the first year, 2001, the airplane, as an analogy with a mortgage, wouuld appreciate to 1320.00. Given the payment, the mortgage balance becomes 1003.44 (1320.00−316.56). The difference (1200.00−1003.44) is the depreciation charge, as shown in Cell H2 of FIG. 1.

Sinking-fund depreciation has some nice and convenient mathematical properities, with some believing it to be the best method of depreciation. Others dislike sinking-fund depreciation, possibly because the charge is initially relatively low, then increases over time. See Column F, FIG. 1.

As will be shown, the early low charges and the late high charges reflects a confusion between recurring income and capital gains. Separation between recurring income and capital gains is required, since arguably most investors seek a recurring income estimate. The second problem with sinking-fund depreciation is that it assumes constant mortgage payments, to use a metaphor—a possible issue since assets are not necessarily used or consumed at a constant rate.

In proportional depreciation, the initial initial purchase price, or value, is allocated, or spread out across multiple future periods as deemed appropriate, as shown in Column H of FIG. 1, where a higher proportion is specified because of the 2004 Olympics.

Pat0034 discloses an accounting system, handling credit and debit posting for future receipts, calculating present values based upon those expected future receipts, and updating accounts. However, it does not offer any guildance regarding determining the future receipts amounts themselves.

There are some nonfmancial assets, such a real estate and trademarks, that seemly have constant Fair-market value. The problem, however, is that current accounting methods do not recognized the opportunity cost of holding such assets.

Handling loans, debt, and bonds, within and outside of accounting systems, and calculating interest, has been done for centuries, with perhaps millions of people performing these functions daily.

Within existing accounting theory and practice, there is a contradiction. If a Company C makes a loan or buys another company, it is considered an investment and accounting follows an investment perspective. If, however, Company C develops a new product or purchases new equipment, it is not considered an investment, but rather an expense, albeit possibly an expense spread across multiple periods. It is standard procedure when considering to make a loan, to buy company, to develop a new product, or to purchase new equipment to apply cash-flow analysis. Accordingly, accounting should adopt methods analogous to cash-flow analysis and should treat loans, acquisitions, new products, and new equipment similarly.

Because of many problems, arguably including the Fundamental Depreciation Problem, many people dismiss both the income statement and balance sheet, and instead focus on cash flow as an objective alternative. But this augments the short-term focus as described above with respect to Company A and Company B, with Company B converting its investment into the airplane into cash within a year, seemingly appearing to be more profitable.

Since clear and accurate accounting methods are fundamental to a sound economy, the Fundamental Depreciation Problems needs to be solved. Accouting needs to return to its accrual roots, recognizing that both net assets and cash receipts flucuate randomly from period to period, and recognizing that its task is to separate trends from fluctuations.

### SUMMARY OF THE INVENTION

Accordingly, besides the objects and advantages of the present invention described elsewhere herein, the objects and advantages of the present invention are to develop an accounting methods for nonfinancial assets that:
Resolves the Fundamental Depreciation Problem, specificially:
   Does not create a short-term bias
   Appropriately values nonfinancial assets
   Distinguishes between capital gains and operational performance
Unifies nonfinancial-asset accounting with financial instrument accounting
Resolves problems with sinking-fund depreciation
Handles lessee and lessor accounting
Handles multiple asset interests diversely owned by multiple parties.

Yet additional objects and advantages will become apparent from a consideration of the ensuing description and drawings.

### BRIEF DESCRIPTION OF THE DRAWINGS

The invention will be more readily understood with reference to the accompanying drawings, wherein:

FIG. 1 shows numerical demonstration of the fundamental depreciation problem.

FIG. 2 shows the relationship between the DataClient and the ApplicationServer.

FIG. 3 shows the DataClient and ApplicationServer connected through the global cloud, the intemet or a WAN/LAN.

FIG. 4 shows calculating Future Pop Values.

FIG. 5 shows the Airplane Value as a function of time.

FIGS. 6A and 6B show income statements for the Base Case example.

FIG. 7 shows a balance sheet for the Base Case example.

FIG. 8 shows a data dump for the Ramp-up Case example.

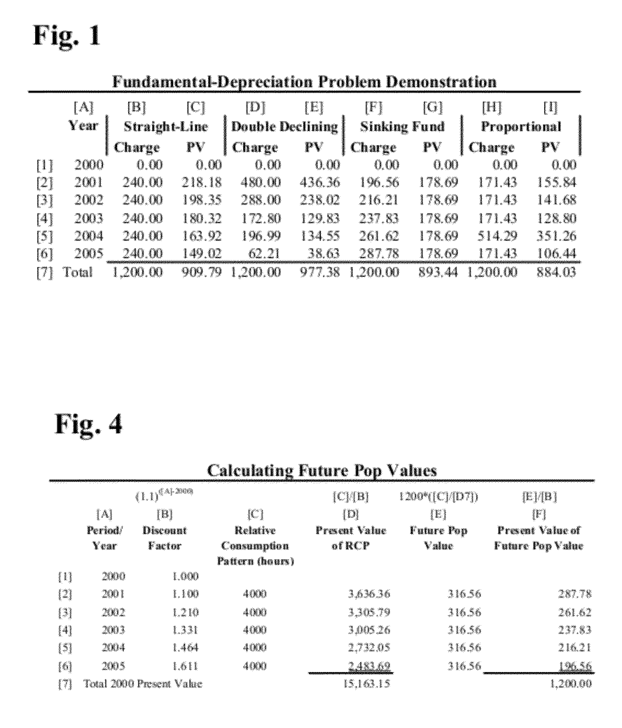

### DETAILED DESCRIPTION OF THE INVENTION

### Introduction

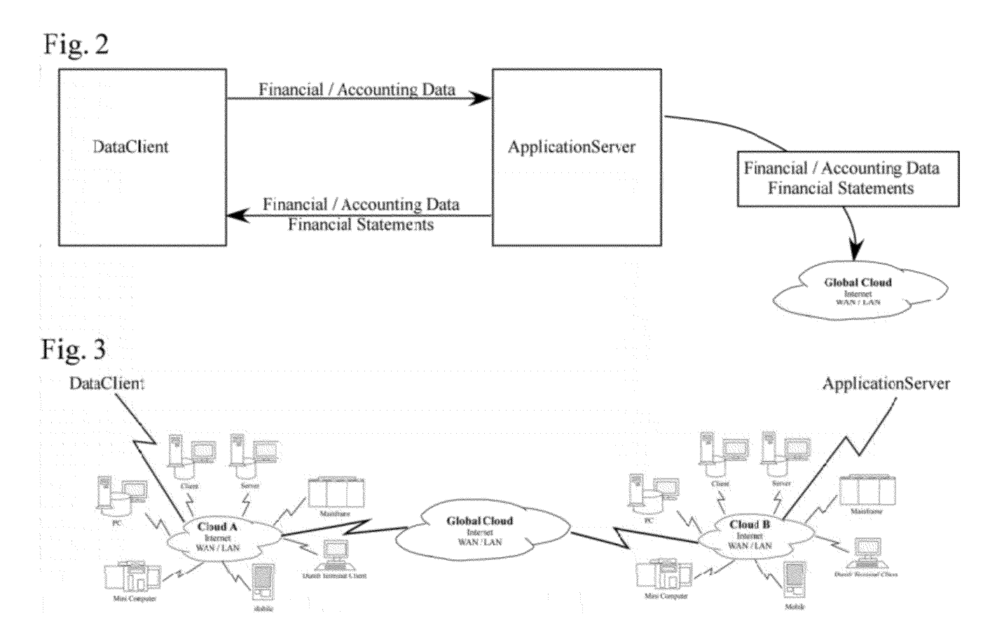

The present invention can operate on most, if not all, types of computer systems, however connected or not connected, as shown in FIGS. 2 and 3. For disclosure purposes, there are two main components: the DataClient and the ApplicationServer, as shown in the Figs. The ApplicationServer receives input, performs calculations, stores both inputted and calculated data, and returns or forwards results. The DataClient submits data to the ApplicationServer and receives results. While the language of the Client-Server computing paradigm is useful and serves as a metaphor here, the present invention is not confined to operating per the Client-Server computing paradigm. Both the DataClient and the ApplicationServer could operate on a single processor or computer system. Alternatively, both could operate rather independently, connected either by the internet or a WAN/LAN, as shown in FIG. 3. Cloud computing is the latest terminology for distributed computing. The ApplicationServer could be considered to operate in the Cloud, as could the DataClient. What is significant here about Cloud computing is that potentially either or both the ApplicationServer and the DataClient themselves could be distributed, each operating on several processors, with executable code, data, and results being passed and moved from processor to processor. The ApplicationServer may or may not provide the DataClient with results; the alternative, of course, is to provide other nodes on the internet or WAN/LAN with results, as shown in FIG. 2.

The computer system as shown in FIGS. 2 and 3, or variations, requires proper programming to execute the present invention, though this is readily accomplished given this teaching that includes computer program source code to execute and demonstrate key aspects of the present invention.

The capitalized term “Company” refers to the entity that is executing the present invention, or having it executed, on its behalf and can be either a for-profit business organization, a government, a nonprofit organization, a trust, an individual, and in fact can be any type of entity that seeks to estimate the Fair value and depreciation expense of any nonfinancial asset.

The difference between a financial asset and a nonfinancial asset is that the former directly yields monetary benefits, while the latter yields benefits not denominated in monetary units. So, for instance, a government bond is a financial asset, clearly yielding monetary benefits, a stream of monetary payments. An airplane is a non-monetary asset, yielding transport service benefits, but not directly monetary benefits. Nonfinancial assets include both products and services; traditional manufacturing plants, buildings, and equipment; raw land; natural resources; intellectual property; service contracts; “depreciating” assets, such as equipment; “constant value” and “appreciating” assets, such as trademarks; and human capital—essentially any type of nonfinancial asset. A prime object of the present invention is to quantify such non-monetary benefits of all types of nonfinancial assets in monetary valuation terms.

Occasionally, one Company's nonfinancial asset is another Company's nonfinancial liability. So while the present disclosure is oriented towards estimating the Fair value and depreciation expense of any nonfinancial asset, associated revenues and expenses, along with associated credits and debits, the presented methods could just as well be used for liabilities: estimating the Fair value and nonusage benefits of any nonfinancial liability, associated revenues and expenses, associated credits and debits, with a general reversal of assets with liabilities, revenues with expenses, and credits with debits.

Much of this disclosure is based upon the previously introduced Base-case, in which Company A purchases an airplane for $1200.00 on the last day of year 2000; the airplane has a five-year life span, and the Company A has a 10% cost of capital and discount rate. This example, its variations, and how it is handled here are meant to be illustrative of the concepts and functioning of the present invention, and is meant to demonstrate a broad application of the present invention's central feature, but should not be construed to limit the central feature: Relative Consumption Pattern Discount Aligning (RCPDA). Similarly, the assets under consideration in this disclosure, usually an airplane, should not be construed to limit the applicability of the present invention to any particular type of nonfinancial asset. Though the example uses an accounting period of a year for illustrative purposes, and assumes activity occurs on the last day of the year, other accounting-period lengths, and other activity days within the period, could be used. In particular, in an actual implementation of the present invention, given today's current accounting practices, the financial quarter of three months should be used, with activity occurring on any, or all, days of the quarter.¹ ¹ Or seconds

Operation of the present invention requires both a discount rate (e.g., 10%) and a purchase price of cost (e.g., $1200). The discount rate is taken as given by the present invention, its determination not discussed, since those in the fields of financial analysis and accounting are very familiar with discount-rate determination. Any given Company may use different discount rates for different nonfinancial assets, which also likely have different purchase prices. If the current discount rate is tied to actual market interest rates or other market prices, then the estimated Fair values and depreciation expenses of any nonfinancial asset are directly tied with the current market. The purchase prices taken as given by the present invention, and are assumed determined by an actual purchase prices, appraisal, market survey, cash-flow present-value analysis, or any other type of current or future valuation method.

The capitalized term “User” refers to a person, or computer system, who operates the present invention on behalf of the Company, and is synonymous with the DataClient.

Throughout this disclosure, the discount rate is expressed in factor form, i.e., 1.10, rather than in decimal or percentage form, i.e., 0.10, and 10%, to spare constant adding and subtracting of 1.0.

The present disclosure focuses on using its central feature, Relative Consumption Pattern Discount Aligning, in a financial accounting context, using spreadsheet-like drawings for pedagogical purposes. The present invention, however, can be used outside of a financial accounting context and/or apart from spreadsheets. So within a financial accounting context, the present invention can be used without spreadsheets, using programming objects, programmed as disclosed here. Alternatively, within a financial accounting context, Users could use spreadsheets to perform calculations as shown here, and then manually or semi-automatically post the results to a financial accounting system, using standard credits and debits interfaces. Alternatively, yet again, completely apart from any financial accounting system, the present invention could be used in an asset management or database system, containing estimated asset Fair values and depreciation expenses as calculated here, with or without using spreadsheet to perform calculations as disclosed. Yet again, the present invention could be used by one or more Users, with or without either a spreadsheet and/or with or without a hand held calculator, for ad hoc analysis, transaction decisions, buy-versus-rent decisions, business plan preparation, and the like. In fact, the present invention can be used in any context where present depreciation methods are used today, with computational support such as a hand held calculator, personal computer, minicomputer, mainframe, or server. The focus here is upon a financial accounting system context, with credits and debits, because it is the most general and complex case: in the context of ad hoc spreadsheet analysis. In ad hoc analysis, only Fair-value valuations and depreciation expenses are likely to be useful, with associated financial accounting system credits and debits of little or no use. Hence, not all the functionality disclosed here is necessarily required by all implementations.

In keeping with prior-art usage, the expression “depreciation expense” is used here to mean the net change in asset value over the course of an accounting period.

From the perspective of the present invention, asset-value change has three components: First, as time progresses, the value of future benefits is closer-at-hand, thus the present value increases, and thus asset value increases. Such increases are considered capital gains. Second, asset consumption occurs that reduces asset value. Asset consumption entails extinguishment of “Future Pop Values”, which will be introduced. Third, model parameter changes occur, triggering asset value changes. Resulting increased valuations are considered capital gains, while decreased valuations are considered capital losses. A key feature of the present invention is isolating the first two components, which are confounded in the prior-art under the general term “depreciation expense.” While the expression “depreciation expense” is occasionally used here to mean a charge or expense, the expression, while extremely commom, is inaccurate. A better expression is “consumption charge.”

### Theory of the Invention

The Fundamental Depreciation Problem, by definition, is the failure to consider present value. It contradicts both common sense and the most basic financial principle—the time value of money—to consider that the purchase price reflects all future embedded value, since it makes no sense for Company A to purchase the airplane, only to wait years to get its original value returned, while the Company could earn 10% elsewhere.

Relative Consumption Pattern Discount Aligning solves the Fundamental Depreciation Problem. Initially the User specifies a Relative Consumption Pattern for the airplane, as shown in Column C, of FIG. 4, the elements being estimated number of annual flying hours. Next, the present value of each Relative Consumption Pattern element is calculated, as shown in Column D; summed, yielding Cell D7 amount, 15,163.15. Next, the purchase price ($1200.00) is divided by the summed present value (15,163.15), yielding a quotient, the Pop Factor. Then each Relative Consumption Pattern element is multiplied by the Pop Factor to yield Future Pop Values, as shown in Column E. Column F shows the present values of these Future Pop Values, summing to $1200.00, equating to the purchase price. Note that the dimension of Column C—hours—cancels, when dividing Column C elements by the sum of Column D, yielding a pure number.

If the Future Pop Values are then taken as time-phase valued delivered or provided by the airplane, three desirable properties emerge: First, the Fundamental Depreciation Problem is resolved, since under this approach or perspective, Company A is paying $1200.00 for $1200.00 in value—a reasonable transaction, aligned with the basic principle in finance—the time value of money. In fact, the transaction characterization aligns with general market equilibrium of theorical economics: purchase price equals (marignal) value. Second, the Future Pop Values can be used as atomistic components of airplane value for analysis. Third, and in particular, the Future Pop Values can be the basis for expensing, in the context of a financial accounting system, with credits and debits. Conceptually, Future Pop Values are ephemeral, lasting only for an instant, during which time they are either converted into something of economic value, or they are lost forever.

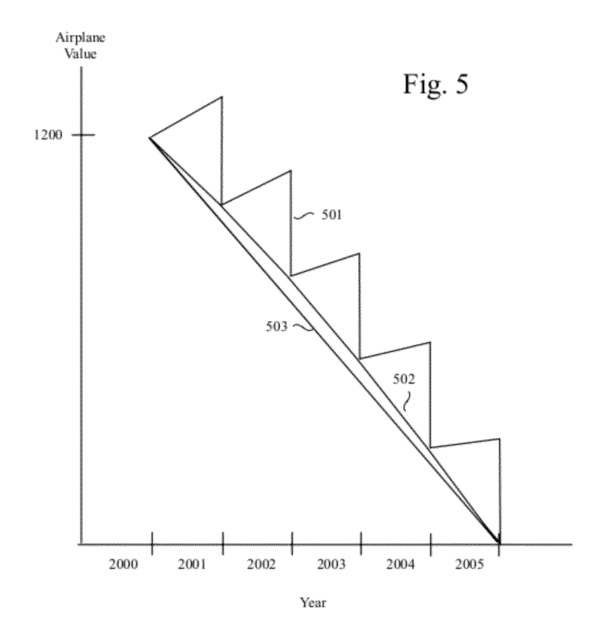

A prime use of Future Pop Values is to determine the airplane's Fair value. At any point in time, the value is simply the present value of the Future Pop Values. Though an airplane would normally be considered a depreciating asset, as shown in the FIG. 5, during each period, its value actually increases, as the realization of Future Pop Values becomes nearer and nearer, until the Pop, when the value instantaneously drops.

If the time separation between the Relative Consumption Pattern elements is reduced from a year to a day, the zigzag value Curve 501 of FIG. 5 becomes smooth arc 502, as shown. (Straight diagonal Line 503 is airplane value under straight-line depreciation.)

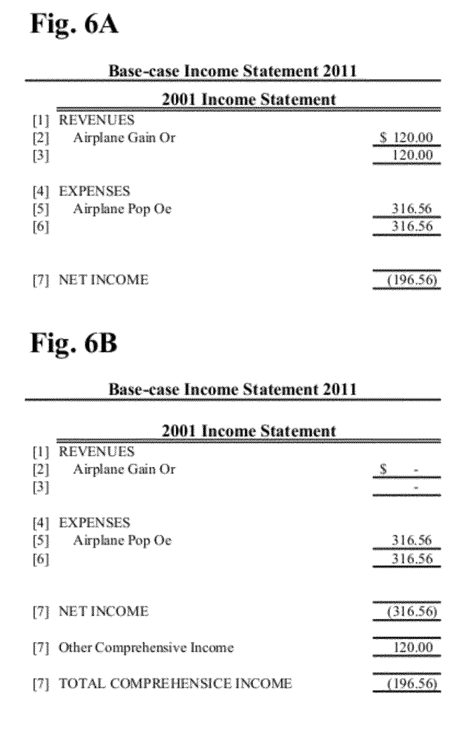

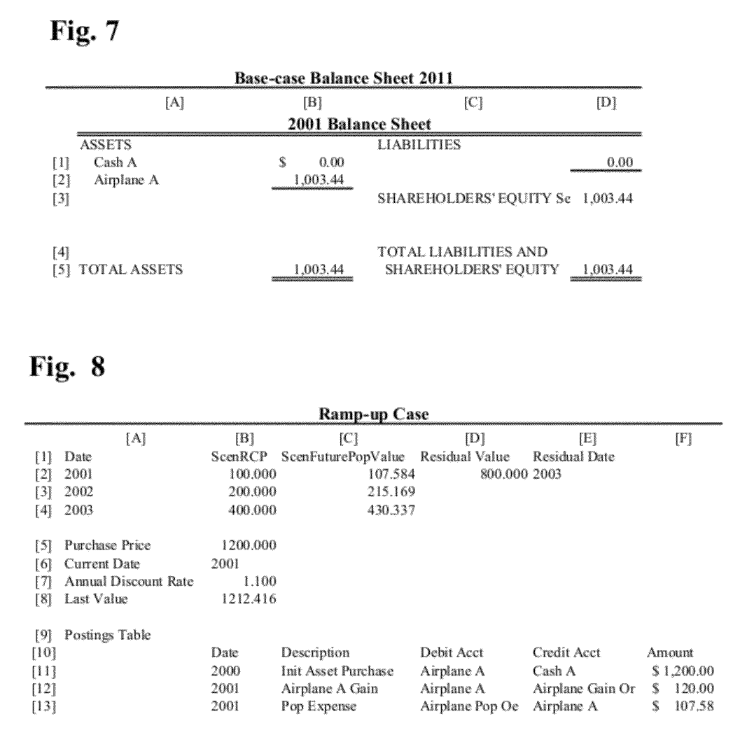

In terms of credits, debits, and financial statements, at the end of year 2000, the airplane is purchased, triggering a debit to an airplane asset account (Airplane A), a credit to cash (Cash A), and an entry on the balance sheet. At the end of the first year, 2001, the present value of the Future Pop Values is calculated, yielding a $1320.00 valuation. The $120.00 gain is debited to the airplane asset account, and credited to a revenue account. When the Pop Expensing Date of the first Future Pop Value is reached, an expense is triggered: a credit to the airplane asset account and a debit to an expense account. This leads to one of the income statements as shown in FIG. 6A or 6B, the difference being whether the $120.00 gain appears above or below the net income line. The resulting balance sheet is shown in FIG. 7.

The Relative Consumption Pattern elements are not necessarily constant, but they should be representative of the likely consumption pattern. Given a choice, it is preferable to estimate and use a marketwide Relative Consumption Pattern, since ultimately the object is valuations and expenses reflective of the market. However, practically speaking, many companies will need to revert to using their own experience and expectations to estimate Relative Consumption Patterns. The pattern elements might be objective, as in the case of hours flow by the airplane, but it could also he subjective, based upon analogy and gut assessment.

As an example of the The Relative Consumption Pattern elements that are not necessarily constant, consider the table in FIG. 8, with data of the Ramp-up case. As can been seen in Cells B2-B4, the elements are not constant, yielding Future Pop Values that are not constant either, as can be seen in Cells C2-C4. This particular case implicitly assumes that Company D is ramping up in a new business, hence the doubling of relative consumption pattern elements. In this case a residual value is considered, $800.00 in 2003. This is handled by reducing the used purchase price to compute the Future Pop Values by the 2000 present value of $800.00. This type of pattern overcomes the problem with EVA penalizing new products and businesses, because it recognizes the ramp up aspects to such endeavers, while ultimately requiring accountability.

### Implementation and Operation

The preferred embodiment is to implement the present invention as a Cloud-based service, with the Users and DataSurver providing data over the internet to the ApplicationServicer, which in turns handles processing and calculations, and then either returns the results to the the DataSurver and/or publishes the results over the internet.

Note that the present invention could also be executed by a single individual, using either a spreadsheet on personal computer, and/or using a handheld calculator, with the single individual replicating all the calculation detail as shown here and/or with the spreadsheet and/or handheld calculator having built-in functionality to execute at least some of the aspects of the present invention, and/or with the spreadsheet and/or handheld calculator having access over the internet to execute at least some aspects of the present invention.

Accordingly, the present disclosure should not be interpreted to bound the present invention with respect to requiring any particular type of computational device.

### Computer-Program Source-Code Introduction

A computer-program source-code listing to demonstrate essential function of the present invention is included with this disclosure. Module ApplicationServer executes the essential elements of the present invention, computing Future Pop Values and using such values to determine asset values as present values. DataServer uses the ApplicationServer to generated necessary credits and debits, which DataServer feeds into its own accounting system, that generates the income statement of Fig. GA and balance sheet of FIG. 7. Both modules use object DataExcbanger to pass data and results between themselves. The execution entry point is function DataServerDo in module DataServer. File LineDump.txt is an output file.

The execution entails handling the Base-case airplane over the course of the five years, with credits and debits being generated and posted, and with income statements and balance sheet being generated, as can be seen in the output file. Ramp-up is the second, more advanced, case, considering residual value. It too entails credits and debits being generated and posted, and with income statements and balance sheet being generated, as can be seen in the output file.

### Conclusion, Ramifications, and Scope

While the above description contains many particulars, these should not be construed as limitations on the scope of the present invention; but rather, as an exemplification of one preferred embodiment thereof. As the reader who is skilled in the invention's domains will appreciate, the invention's description here is oriented towards facilitating ease of comprehension. Such a reader will also appreciate that the invention's breadth of scope can be improved by applying both prior-art techniques and readily apparent improvements.

Many variations and many add-ons to the preferred embodiment are possible. Examples of variations and add-ons include, without limitation:
1. Rather than requiring a User to specify Relative Consumption Patterns, an implementation could have the User specify template parameters, resulting in the implementation generating Relative Consumption Patterns. So, for example, the User might indicate that all elements of Relative Consumption Pattern are constant and that the asset lifespan is six years, resulting in the generation of a Relative Consumption Pattern spanning six years, ultimately leading to Future Pop Values for each day.
2. At any time, Future Pop Values can be taken as a basis for Relative Consumption Pattern Elements, thus facilitating passing information from one User to another,
3. Pop Factor does not necessarily need to be calculated based upon present values calculated as of the Original Date, but rather could use any date as a reference date anchor date.
4. Rather than the User estimating Relative Consumption Pattern elements, asset suppliers could do the estimation. The advantage is to capitalize on the knowledge of suppliers, who probably know their products better than their customers.
5. The algebraic calculations of the present invention can be done in different sequences, with no significance, other than perhaps computer execution time.
6. One could conceivably estimate Future Pop Values directly, bypassing the Relative Consumption Pattern specification, with the only requirement being that the summed net present values equals the purchase price. Such an estimation ideally would be done with calculation assistance, to assure that the net present values of the estimated Future Pop Values equals the purchase price. Once estimated, such Future Pop Values could be handled as described here.

### Copyright Notice

This application includes a computer-program source-code listing written in C++ for Microsoft Visual C++, Version 6.0, Visual Studio. Included is a computer-output file.

Both the computer-program source-code listing and the computer-output file are subject to copyright protection. The copyright owner has no objection to the facsimile reproduction by anyone of the patent disclosure, as it appears in the U.S. Patent and Trademark Office patent files or records, as it appears in the patent files or records of foreign counterparts or international instrumentalities, but otherwise reserves all copyright rights whatsoever.

I claim:

1: A computer system comprising:
accessing Relative Consumption Pattern elements;
calculating a present value for said Relative Consumption Pattern elements; and
using said calculated present value to calculate at least one Future Pop Value.

2: The computer system according to claim 1, further comprising:
using said calculated at least one Future Pop Value to generate credits and debits for a financial accounting system.
